(19) United States
(12) Patent Application Publication
(10) Pub. No.: US 2016/0053148 A1
(43) Pub. Date: Feb. 25, 2016

(54) SOLVENT-FREE SILICONE ADHESIVE AGENT COMPOSITION AND ADHESIVE ARTICLE

(71) Applicant: SHIN-ETSU CHEMICAL CO., LTD., Tokyo (JP)

(72) Inventor: Osamu TSUCHIDA, Annaka-shi, Gunma (JP)

(73) Assignee: SHIN-ETSU CHEMICAL CO., LTD., Tokyo (JP)

(21) Appl. No.: 14/783,131

(22) PCT Filed: Feb. 21, 2014
(86) PCT No.: PCT/JP2014/054144

§ 371 Date: Oct. 8, 2015

(30) Foreign Application Priority Data
Apr. 12, 2013 (JP) 2013-083680

(51) Int. Cl. C09J 183/06; C09J 7/02

(52) U.S. Cl. CPC C09J 183/06; C09J 7/0207

(57) ABSTRACT

Provided is a solvent-free silicone adhesive agent composition comprising: (A) an organopolysiloxane which has at least two alkenyl-group-containing organic group per molecule in an amount of 40 to 95 parts by mass; (B) an organopolysiloxane which is composed of a R²₃SiO_{1/2} unit (wherein R²'s independently represent a monovalent hydrocarbon group that has 1 to 10 carbon atoms and does not have an aliphatic unsaturated bond or an alkenyl group that has 2 to 6 carbon atoms) and a SiO_{4/2} unit and has a (R²₃SiO_{1/2} unit)/(SiO_{4/2} unit) ratio of 0.6 to 1.0 by mole in an amount of 5 to 60 parts by mass, wherein the total amount of the components (A) and (B) is 100 parts by mass; (C) an organohydrogenpolysiloxane which has at least three Si—H groups per molecule and has a Si—H modification ratio of 30 mol % or more in such an amount that ratio of the amount of the Si—H groups to the amount of the alkenyl groups in the component (A) becomes 0.2 to 10 by mole; and (D) a platinum group metal catalyst. The solvent-free silicone adhesive agent composition can be cured at a temperature as low as 100° C. or lower.

### TECHNICAL FIELD

This invention relates to a solventless silicone pressure-sensitive adhesive composition and a pressure-sensitive adhesive article using the composition.

### BACKGROUND ART

Pressure-sensitive adhesives (PSAs) are used in a variety of situations including labels to be attached to products and adhesive tapes. In conjunction with the advance of the electronic terminal-related technology, the field of PSA application is nowadays expanded to PSA films for display protection and protective films during product fabrication processes. Besides the surface protection, PSAs are also utilized in optical members by taking advantage of their transparency. The application of PSA used in the product interior, as typified by optically clear adhesive tape (OCA tape) is explored.

PSAs are generally classified into acrylic, rubber, and silicone types, each having advantages and shortcomings. Silicone PSAs are economically inferior to acrylic and rubber PSAs because of expensive raw materials, but are superior to the two PSAs in such characteristics as heat resistance, freeze resistance, weathering, chemical resistance and electric insulation.

Currently, mobile phones and electronic terminals are on widespread use. Most of adhesive films for the protection of these displays are based on silicone PSAs. Since silicone is characterized by good wetting to adherends, the entrainment of air bubbles upon attachment is eliminated, spontaneous shifting or peeling is avoided, and re-attachment is possible due to good re-workable property (see Patent Document 1: JP-A H07-197008). For the protective films used during product fabrication processes in which similar properties and heat resistance are necessary, PSA films based on silicone PSAs are used in large.

Among mobiles phones, those terminals of higher performance than conventional terminals, known as smartphones, are rapidly widespreading. Most of smartphones can be operated by touching the display, known as touch panel, rather than the conventional buttons. Tablet terminals are analogous while they are portable computers equipped with touch panels. With the spread of such terminals which are equipped with displays of larger area, the demand for PSA films for screen protection is increasing.

One measure believed effective for increasing the productivity of these films is by improving the curability of PSA layer. The improved curability ensures that products are manufactured at a higher speed than in the prior art.

The silicone PSAs known thus far, however, must be cured at temperatures substantially in excess of 100° C. (see Patent Document 1: JP-A H07-197008; Patent Document 2: JP 4678847 and Patent Document 3: JP 3604716). A further improvement in curability is desired. In the prior art, some PSAs can be cured at low temperatures (see Patent Document 4: JP 2631098 and Patent Document 5: JP 3130176), but require a cure time of several minutes. There is a need for brief cure. Patent Document 6: JP-A 2011-012092 refers to low-temperature cure, but uses a large amount of solvent like prior art silicone PSAs. No reference has been made to the low-temperature cure technology of solventless silicone PSAs.

As discussed above, the possibility of low-temperature cure means good curability, which contributes to an improvement in productivity. Although only those substrates which are resistant to high temperatures necessary for the curing of silicone PSAs are applicable heretofore, the possibility of low-temperature cure also suggests that even less heat resistant substrates are acceptable.

### SUMMARY OF THE INVENTION

### Problems to be Solved by the Invention

An object of the invention, which has been made under the above circumstances, is to provide a solventless silicone PSA composition which is curable at a low temperature of 100° C. or lower, and a PSA article.

### Means for Solving the Problems

Making extensive investigations to attain the above object, the inventor has found that by combining specific components, a silicone PSA composition can be prepared as a solventless system and is more effectively cured at low temperature than prior art silicone PSAs. The invention is predicated on this finding.

Accordingly, the invention provides a solventless silicone PSA composition and PSA article as defined below.

[1] A solventless silicone pressure-sensitive adhesive composition comprising

(A) 40 to 100 parts by mass of an organopolysiloxane represented by the average compositional formula (1) and having at least two alkenyl-containing organic groups per molecule,

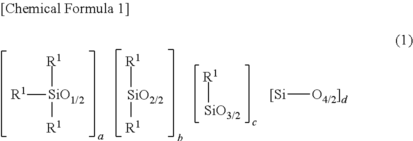

wherein R¹ which may be the same or different is a C₁-C₁₀ monovalent hydrocarbon group, at least two C₂-C₁₀ alkenyl-containing organic groups being contained, a is an integer of at least 2, b is an integer of at least 1, c and d each are an integer of at least 0, and 100≦a+b+c+d≦2,000,

(B) 0 to 60 parts by mass of an organopolysiloxane comprising R²₃SiO_{1/2} units and SiO_{4/2} units wherein R² is each independently an aliphatic unsaturation-free C₁-C₁₀ monovalent hydrocarbon group or C₂-C₆ alkenyl group, in a molar ratio R²₃SiO_{1/2}/SiO_{4/2} of 0.6 to 1.0, provided that the total of components (A) and (B) is 100 parts by mass,

(C) an organohydrogenpolysiloxane represented by the average compositional formula (2) and containing at least three Si—H groups per molecule, the content of Si—H groups being up to 30 mol % of all silicon-bonded organic groups, in an amount to provide 0.2 to 10 moles of Si—H groups per mole of alkenyl groups in components (A) and (B),

R³ₑH_{f}SiO_{(4-e-f)/2} (2)

wherein R³ is a substituted or unsubstituted C₁-C₁₀ monovalent hydrocarbon group, e and f are numbers in the range: e>0, f>0, and 0<e+f≦3, and

(D) a platinum group metal base catalyst for curing by promoting hydrosilylation addition reaction between alkenyl groups in component (A) and Si—H groups in component (C), in an amount to give 1 to 500 ppm of metal per 100 parts by mass of components (A), (B), and (C) combined.

[2] The composition of [1], comprising 40 to 95 parts by mass of component (A) and 5 to 60 parts by mass of component (B).

[3] The composition of [1] or [2] wherein component (C) has the general formula (3):

R⁴₃Si—O—(SiR⁵₂—O)_{g}—(SiR⁶H—O)ₕ—O—SiR⁷₃ (3)

wherein R⁴ and R⁷ each are a C₁-C₁₀ monovalent hydrocarbon group or hydrogen, R⁵ and R⁶ each are a C₁-C₁₀ monovalent hydrocarbon group, g and h are numbers in the range: 1≦g≦100 and 3≦h≦80.

[4] The composition of [1], [2] or [3] which cures at a temperature of 100° C. or lower.

[5] The composition of [4] which cures at a temperature of 80° C. or lower.

[6] The composition of any one of [1] to [5] which cures into a cured product having a rubber hardness of up to 40 as measured by an Asker C hardness meter.

[7] The composition of any one of [1] to [6], further comprising (E) 0.005 to 2 parts by mass of a reaction regulator per 100 parts by mass of components (A), (B), and (C) combined.

[8] A pressure-sensitive adhesive article obtained by coating and curing the solventless silicone pressure-sensitive adhesive composition of any one of [1] to [7] onto a substrate.

### Advantageous Effects of the Invention

The solventless silicone PSA composition enables cure under energy-saving conditions including fast cure and low-temperature cure.

### EMBODIMENT FOR CARRYING OUT THE INVENTION

Now the solventless silicone pressure-sensitive adhesive composition of the invention is described in detail.

### [Component A]

Component (A) is an organopolysiloxane having at least two alkenyl-containing organic groups per molecule. Specifically, the organopolysiloxane has a structure of the average compositional formula (1).

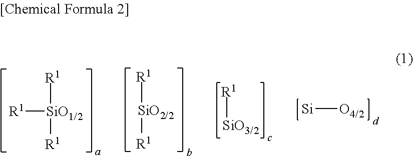

In formula (1), R¹ which may be the same or different is a C₂-C₁₀ monovalent hydrocarbon group and at least two of R¹ are C₂-C₁₀ alkenyl-containing organic groups. Examples of the monovalent hydrocarbon group include alkyl groups such as methyl, ethyl, propyl and butyl; cycloalkyl groups such as cyclohexyl; aryl groups such as phenyl; aralkyl groups such as benzyl; and substituted forms of the foregoing groups in which some or all hydrogen atoms attached to carbon atoms are substituted by halogen atoms or other groups, with suitable substituted groups including trifluoromethyl and 3,3,3-trifluoropropy. Of these, saturated aliphatic groups and aromatic groups are preferable, with methyl and phenyl being most preferred.

Examples of the alkenyl-containing organic group include alkenyl groups such as vinyl, ally, hexenyl and octenyl; acryloylalkyl and methacryloylalkyl groups such as acryloylpropyl, acryloylmethyl and methacryloylpropyl; cycloalkenylalkyl groups such as cyclohexenylethyl; and alkenyloxyalkyl groups such as vinyloxypropyl. Of these, vinyl is preferred.

The content of alkenyl groups in component (A) is preferably 0.005 to 0.08 mole, more preferably 0.008 to 0.06 mole per 100 g of the organopolysiloxane.

With respect to the subscripts a to d in the average compositional formula (1), a is an integer of at least 2, preferably 2 to 10, and more preferably 2 to 6, b is an integer of at least 1, preferably 90 to 1,900, and more preferably 180 to 1,700, c and d each are an integer of at least 0, and 100≦a+b+c+d≦2,000, preferably 200≦a+b+c+d≦1,800. If the sum of a+b+c+d is less than 100, reaction may be retarded due to excessive crosslinking points. If the sum of a+b+c+d exceeds 2,000, the composition may have a very high viscosity and thus become difficult to handle.

The component (A) preferably has a viscosity at 25° C. of 100 to 100,000 mPa·s, more preferably 500 to 80,000 mPa·s. In order to formulate a solventless silicone PSA, the viscosity of the base polymer should be reasonably low. It is then difficult to use a high viscosity, nearly solid organopolysiloxane, referred to as gum, as in the prior art.

It is noted that the viscosity is measured at 25° C. by a rotational viscometer (the same applies hereinafter).

Component (A) is generally obtained from ring-opening polymerization of a cyclic low-molecular-weight siloxane such as octamethylcyclotetrasiloxane in the presence of a catalyst. Since the polymerization product contains the reactant, cyclic low-molecular-weight siloxane, it is preferably purified prior to use by heating under reduced pressure while passing an inert gas into the product, for distilling off the cyclic siloxane.

### [Component B]

Component (B) is an organopolysiloxane comprising R²₃SiO_{1/2} units and SiO_{4/2} units wherein R² is each independently an aliphatic unsaturation-free C₁-C₁₀ monovalent hydrocarbon group or a C₂-C₆ alkenyl group, in a molar ratio R²₃SiO_{1/2}/SiO_{4/2} of 0.6 to 1.0, preferably 0.65 to 0.9. If the molar ratio of R²₃SiO_{1/2}/SiO_{4/2} is less than 0.6, there may be a drop of bonding force (or adhesion strength) or tack of the cured product. If the molar ratio exceeds 1.0, there may be a drop of bonding or retaining force.

Suitable C₁-C₁₀ monovalent hydrocarbon groups represented by R² include alkyl groups of preferably 2 to 6 carbon atoms such as methyl, ethyl, propyl and butyl; aryl groups of preferably 6 to 10 carbon atoms such as phenyl and tolyl; and aralkyl groups of preferably 7 to 10 carbon atoms such as benzyl. Examples of the C₂-C₆ alkenyl group include vinyl, allyl, and butenyl.

Component (B) may be a mixture of two or more organopolysiloxanes. Also R²₂SiO_{3/2} units and R²SiO_{2/2} units may be incorporated in the organopolysiloxane (B) in an amount of up to 20 mol % based on component (B) as long as the desired properties are not compromised.

Component (B) may be subjected to condensation reaction in the presence of a catalyst. This is the reaction of hydrolyzable groups available on the surface, from which improvements in bonding force and the like are expectable. The reaction is performed in the presence of an alkaline catalyst at room temperature to reflux temperature and may be followed by neutralization if necessary.

Examples of the alkali catalyst include metal hydroxides such as lithium hydroxide, sodium hydroxide, potassium hydroxide and calcium hydroxide; carbonates such as sodium carbonate and potassium carbonate; hydrogencarbonates such as sodium hydrogencarbonate and potassium hydrogencarbonate; metal alkoxides such as sodium methoxide and potassium butoxide; organometals such as butyl lithium; potassium silanolate; and nitrogen compounds such as ammonia gas, aqueous ammonia, methylamine, trimethylamine and triethylamine, with ammonia gas and aqueous ammonia being preferred. The temperature of condensation reaction may range from room temperature to the reflux temperature of an organic solvent. The reaction time may be 0.5 to 20 hours, preferably 1 to 16 hours, though not particularly limited.

At the end of reaction, a neutralizing agent may be added for neutralizing the alkaline catalyst, if necessary. Examples of the neutralizing agent include acidic gases such as hydrogen chloride and carbon dioxide; organic acids such as acetic acid, octylic acid and citric acid; and mineral acids such as hydrochloric acid, sulfuric acid and phosphoric acid. Where ammonia gas, aqueous ammonia or low-boiling amine compound is used as the alkaline catalyst, it may be distilled off by bubbling an inert gas such as nitrogen.

Provided that the total of organopolysiloxanes as components (A) and (B) is 100 parts by mass, the amount of component (A) added is 40 to 100 parts, preferably 40 to 95 parts, and more preferably 45 to 95 parts by mass and the balance (i.e., 0 to 60 parts, preferably 5 to 60, and more preferably 5 to 55 parts by mass) is component (B). If component (A) is less than 40 parts by mass, the composition may have too high a viscosity to handle.

### [Component C]

Component (C) is an organohydrogenpolysiloxane containing at least three Si—H groups per molecule, the content of which is up to 30 mol % of all organic groups in the siloxane. Specifically, the organopolysiloxane has a structure of the average compositional formula (2).

R³ₑH_{f}SiO_{(4-e-f)/2} (2)

In formula (2), R³ is a substituted or unsubstituted Cₗ-C₁₀ monovalent hydrocarbon group preferably free of aliphatic unsaturation. Examples include alkyl groups such as methyl, ethyl, propyl and butyl; cycloalkyl groups such as cyclohexyl; aryl groups such as phenyl; aralkyl groups such as benzyl; and substituted forms of the foregoing groups in which some or all hydrogen atoms attached to carbon atoms are substituted by halogen atoms or other groups, with suitable substituted groups including trifluoromethyl and 3,3,3-trifluoropropyl. Of these, saturated aliphatic groups and aromatic groups are preferable, with methyl and phenyl being most preferred.

In formula (2), e and f are numbers in the range: e>0, f>0, and 0<e+f≦3, preferably 0≦e≦2, 0≦f≦2, and 1≦e+f≦3,

Preferably component (C) has a structure of the general formula (3).

R⁴₃Si—O—(SiR⁵₂—O)_{g}—(SiR⁶H—O)ₕ—O—SiR⁷₃ (3)

In formula (3), R⁴ and R⁷ each are a C₁-C₁₀ monovalent hydrocarbon group or hydrogen. R⁵ and R⁶ each are a C₁-C₁₀ monovalent hydrocarbon group, preferably free of aliphatic unsaturation. Examples include alkyl groups such as methyl, ethyl, propyl and butyl; cycloalkyl groups such as cyclohexyl; aryl groups such as phenyl; aralkyl groups such as benzyl; and substituted forms of the foregoing groups in which some or all hydrogen atoms attached to carbon atoms are substituted by halogen atoms or other groups, with suitable substituted groups including trifluoromethyl and 3,3,3-trifluoropropyl. Of these, saturated aliphatic groups and aromatic groups are preferable, with methyl and phenyl being most preferred.

In formula (3), g is an integer in the range: 1≦g≦100, preferably 3≦g≦80, and h is an integer in the range: 3≦h≦80, preferably 4≦h≦70.

Component (C) is added in such an amount that the molar ratio of Si—H groups in component (C) to total alkenyl groups in components (A) and (B) may fall in the range of 0.2/1 to 10/1, preferably 0.5/1 to 8/1. If the molar ratio of Si—H/alkenyl is less than 0.2, the crosslinking density may become low and the cured product has low cohesive and retaining forces. If the molar ratio exceeds 10, the crosslinking density may become too high to gain appropriate bonding force and tack.

Component (C) is generally prepared by ring-opening polymerization of a cyclic low-molecular-weight siloxane such as octamethylcyclotetrasiloxane and a SiH-containing siloxane such as tetramethylcyclotetrasiloxane in the presence of an acid catalyst. Since the polymerization product contains the reactant, cyclic low-molecular-weight siloxane, it is preferably purified prior to use by heating under reduced pressure while passing an inert gas into the product, for distilling off the cyclic siloxane.

The Si—H content (referred to as Si—H modification degree, hereinafter) of component (C) is up to 30 mol %, preferably up to 28 mol % relative to all organic groups in the organopolysiloxane (C). The lower limit of Si—H modification degree is at least 0.5 mol %, preferably at least 1 mol %. Si—H groups are functional groups used in hydrosilylation reaction with alkenyl groups such as vinyl of component (A). Several studies reveal that as the proportion of Si—H groups in the structure becomes lower (i.e., Si—H modification degree becomes lower), the curability becomes higher. This is presumably because the higher the Si—H modification degree, the shorter is the physical distance between Si—H groups, and the initial reacted site becomes a steric hindrance for a subsequent Si—H group to react, resulting in slow consecutive reactions and less curability. When component (C) is prepared by the above method, the average structure is merely obtained. However, it is believed that as the amount of SiH-containing siloxane used is reduced, the resulting organopolysiloxane contains Si—H groups spaced farther apart from one another. If the Si—H modification degree is less than 0.5 mol %, the crosslinking density may be too low to provide a cohesive force.

Component (C) has a viscosity at 25° C. in the range of 1 to 1,000 mPa·s, preferably 2 to 500 mPa·s, but is not limited thereto.

### [Component D]

Component (D) is a platinum group metal base catalyst for curing by promoting hydrosilylation addition reaction between alkenyl groups in component (A) and Si—H groups in component (C). Examples of the center metal include platinum, palladium, iridium, rhodium, osmium, and ruthenium, with platinum being preferred. Suitable platinum catalysts include chloroplatinic acid, chloroplatinic acid in alcohols, reaction products of chloroplatinic acid with alcohols, reaction products of chloroplatinic acid with olefin compounds, and reaction products of chloroplatinic acid with vinyl-containing siloxanes.

Component (D) is added in such an amount as to give 1 to 500 ppm, preferably 2 to 450 ppm of metal based on 100 parts by mass of components (A), (B), and (C) combined. Less than 1 ppm of metal may result in slow reaction and undercure, failing to exert the desired effects of bonding and retaining forces. With more than 500 ppm of metal, the cured composition may become less flexible.

### [Component E]

If desired, the solventless silicone PSA composition may further comprise a reaction regulator as component (E). When the silicone PSA composition is prepared or applied to the substrate, the regulator serves to prevent addition reaction from starting prior to heat curing and to prevent the treatment fluid from thickening or gelling. The reaction regulator coordinates with the platinum group metal as the addition reaction catalyst to control the addition reaction, but when heated for curing, releases the coordination, allowing the catalyst to develop its activity. Any reaction regulators for the prior art addition reaction-curable silicone compositions may be used. Examples of the reaction regulator include 3-methyl-1-butyn-3-ol, 3-methyl-1-pentyn-3-ol, 3,5-dimethyl-1-hexyn-3-ol, 1-ethynylcyclohexanol, 3-methyl-3-trimethylsiloxy-1-butyne, 3-methyl-3-trimethylsiloxy-1-pentyne, 3,5-dimethyl-3-trimethylsiloxy-1-hexyne, 1-ethynyl-1-trimethylsiloxycyclohexane, bis(2,2-dimethyl-3-butynoxy)dimethylsilane, 1,3,5,7-tetramethyl-1,3,5,7-tetravinylcyclotetrasiloxane, 1,1,3,3-tetramethyl-1,3-divinyldisiloxane, maleic acid esters, and adipic acid esters.

Component (E) is added in an amount of 0.005 to 2 parts, preferably 0.01 to 1 Part by mass per 100 parts by mass of components (A), (B) and (C) combined. Less than 0.005 Part by mass of component (E) may provide a poor reaction inhibiting effect, allowing unexpected cure to start prior to use. More than 2 parts by mass of component (E) may provide a strong reaction inhibiting effect, failing in appropriate curability.

The solventless silicone PSA composition may further comprise various additives such as pigments, fillers, antistatic agents, and antioxidants of organic or inorganic compounds as long as the desired properties are not compromised.

The solventless silicone PSA composition is characterized in that the cure rate is higher than that of prior art PSA compositions, and in addition, the cured product has flexibility and a low rubber hardness. Therefore, the cured product can conform to minor unevenness to which the prior PSA tapes or films cannot.

The solventless silicone PSA composition cures into a cured product which preferably has a rubber hardness of up to 40 as measured by an Asker C hardness meter according to JIS S-6050. Herein, the lower limit of hardness is preferably at least 1.

The solventless silicone PSA composition may be coated and heat cured or hot pressed to various substrates to form PSA articles.

The substrate may be selected from paper, plastic films, and glass. Examples of the paper include woodfree paper, coated paper, art paper, glassine paper, polyethylene-laminated paper, and kraft paper. Suitable plastic films include polyethylene film, polypropylene film, polyester film, polyimide film, polyvinyl chloride film, polyvinylidene chloride film, polyvinyl alcohol film, polycarbonate film, polystyrene film, ethylene-vinyl acetate copolymer film, ethylene-vinyl alcohol copolymer film, and triacetyl cellulose film. The glass used herein is not particularly limited with respect to the thickness and type, and even chemically strengthened glass is acceptable. The substrates are not limited to those listed herein.

For improving the adhesion between the substrate and the PSA layer, the substrate may be pretreated such as by primer treatment, corona treatment, etching treatment, plasma treatment, or sand blasting.

Any well-known coating means or method may be used. For example, a comma coater, lip coater, roll coater, die coater, knife coater, blade coater, rod coater, kiss-roll coater, and gravure coater may be used. Screen printing, dipping and casting methods are also acceptable.

With respect to the curing conditions, the curing temperature preferably ranges from 40° C. to 100° C., more preferably from 50° C. to 80° C. If the curing temperature is lower than 40° C., the composition may not fully cure. If the curing temperature is higher than 100° C., substrates with low heat resistance may not be used. The curing time may be 20 seconds to 30 minutes, but not limited thereto.

Since the composition of the invention does not contain any solvent, not only application methods for common silicone PSAs are effective, but press molding is also effective in forming thick film. On a flat rigid plate, a substrate and the solventless silicone PSA composition are rested, and another substrate is rested thereon. A stencil plate of adjustable thickness may be used to control the shape of the cured composition, and a heated metal member may be pressed for a certain time to cure the composition. The pressing conditions include a temperature of the pressing metal member in the range of 80 to 100° C. and a pressing time of 20 seconds to 60 minutes, but are not limited thereto. In such press molding, a substrate/PSA layer/substrate structure, that is, PSA layer sandwiched between substrates is constructed. When one substrate used has a parting agent coated thereon, a two-layer structure of substrate and PSA layer may be obtained after peeling the one substrate. When both substrates used have a parting agent coated thereon, the PSA layer alone is available after peeling both the substrates. It is noted that when the substrates used have not been coated with any parting agent, the article takes the sandwich structure of substrate/PSA layer/substrate because it is difficult to peel the substrates.

A cured product of the solventless silicone PSA composition can also be prepared by potting. Although potting of the existing solvent-type silicone PSA compositions is difficult because bubbles are left due to solvent volatilization, potting is possible with the inventive silicone PSA composition, which is of solventless type. In case bubbles are entrapped during pouring into a container, the bubbles can be removed under reduced pressure. If it is desired to take out the cured composition from the container, the container should have been treated with a parting agent before pouring of the composition. For example, fluorine and silicone base parting agents may be used.

In some cases, the solventless silicone PSA composition is difficult to use as such. Where use conditions such as inefficient handling must be ameliorated, it is acceptable to add an organic solvent to the composition prior to use as long as the desired properties are not compromised.

### EXAMPLES

Examples of the invention are given below by way of illustration and not by way of limitation. In the following chemical formulae, Me stands for methyl and Vi for vinyl.

### Example 1

Two components, 95 parts by mass of dimethylpolysiloxane (A-1) containing vinyl at both ends having the average compositional formula (4):

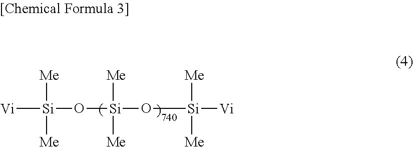

and 5 parts by mass as nonvolatile of a 60 wt % toluene solution of organopolysiloxane (B) consisting of Me₃SiO_{1/2} units and SiO₂ units in a molar ratio (Me₃SiO_{1/2}/SiO₂) of 0.85 were mixed in a container. The mixture was heated at 150° C. to distill off toluene and then heated under reduced pressure at 130° C. to further distill off toluene. To 100 parts by mass of this composition, 9.81 parts by mass of organohydrogenpolysiloxane (C-1) having the average compositional formula (5):

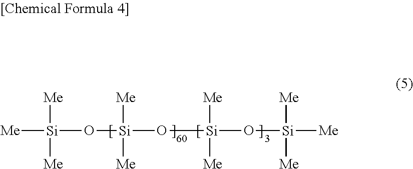 [SMILES: C[Si](C)(C)O[Si](C)(C)O[Si](C)(C)O[Si](C)(C)C]

and 0.1 Part by mass of 1-ethynyl-1-cyclohexanol as a regulator were added. They were mixed and stirred, yielding a solventless silicone PSA composition.

### Example 2

A solventless silicone PSA composition was prepared as in Example 1 except that 3.35 parts by mass of organohydrogenpolysiloxane (C-2) having the average to compositional formula (6) was used instead of component (C-1) in Example 1.

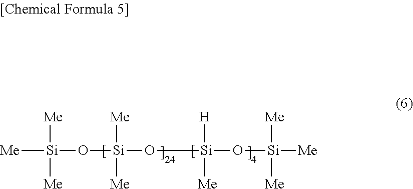

### Example 3

A solventless silicone PSA composition was prepared as in Example 1 except that 1.61 parts by mass of organohydrogenpolysiloxane (C-3) having the average compositional formula (7) was used instead of component (C-1) in Example 1.

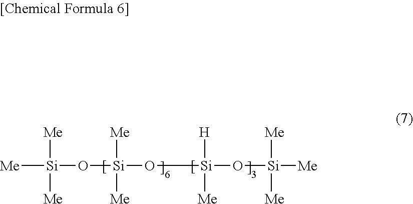

### Example 4

A solventless silicone PSA composition was prepared as in Example 1 except that 0.83 Part by mass of organohydrogenpolysiloxane (C-4) having the average compositional formula (8) was used instead of component (C-1) in Example 1.

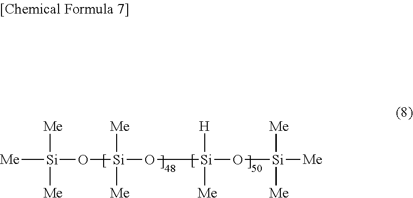

### Comparative Example 1

A solventless silicone PSA composition was prepared as in Example 1 except that 0.56 Part by mass of organohydrogenpolysiloxane (C-5) having the average compositional formula (9) was used instead of component (C-1) in Example 1.

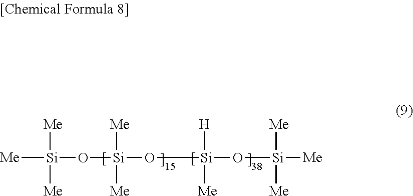

### Comparative Example 2

A solventless silicone PSA composition was prepared as in Example 1 except that 0.40 Part by mass of organohydrogenpolysiloxane (C-6) having the average compositional formula (10) was used.

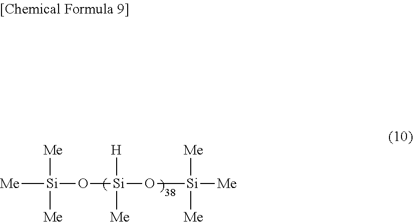

### Example 5

Two components, 60 parts by mass of dimethylpolysiloxane (A-2) containing vinyl at both ends having the average compositional formula (11):

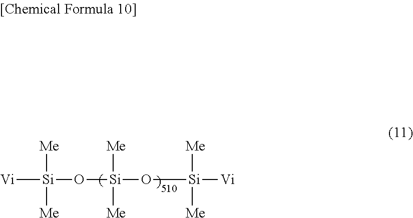

and 40 parts by mass as nonvolatile of a 60 wt % toluene solution of organopolysiloxane (B) consisting of Me₃SiO_{1/2} units and SiO₂ units in a molar ratio (Me₃SiO_{1/2}/SiO₂) of 0.85 were mixed in a container. The mixture was heated at 150° C. to distill off toluene and then heated under reduced pressure at 130° C. to further distill off toluene. To 100 parts by mass of this composition, 9.57 parts by mass of organohydrogenpolysiloxane (C-1) having the average compositional formula (5):

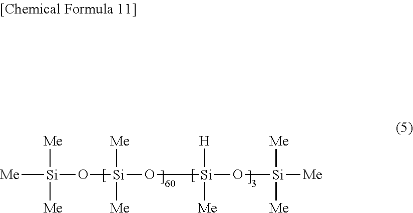

and 0.1 Part by mass of 1-ethynyl-1-cyclohexanol as a regulator were added. They were mixed and stirred, yielding a solventless silicone PSA composition.

### Example 6

A solventless silicone PSA composition was prepared as in Example 5 except that 3.27 parts by mass of organohydrogenpolysiloxane (C-2) having the average compositional formula (6) was used instead of component (C-1) in Example 5.

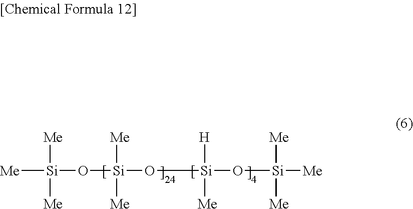

### Example 7

A solventless silicone PSA composition was prepared as in Example 5 except that 1.57 parts by mass of organohydrogenpolysiloxane (C-3) having the average compositional formula (7) was used instead of component (C-1) in Example 5.

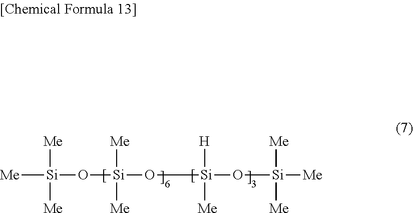

### Example 8

A solventless silicone PSA composition was prepared as in Example 5 except that 0.81 Part by mass of organohydrogenpolysiloxane (C-4) having the average compositional formula (8) was used instead of component (C-1) in Example 5.

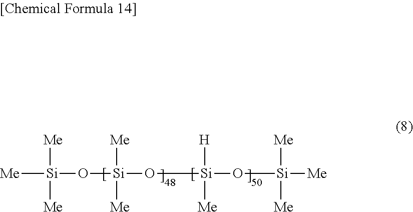

### Comparative Example 3

A solventless silicone PSA composition was prepared as in Example 5 except that 0.55 Part by mass of organohydrogenpolysiloxane (C-5) having the average compositional formula (9) was used instead of component (C-1) in Example 5.

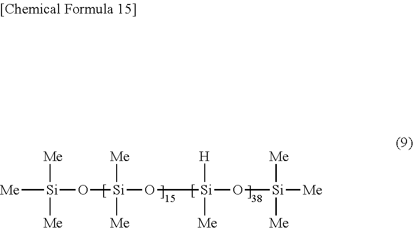

### Comparative Example 4

A solventless silicone PSA composition was prepared as in Example 5 except that 0.39 Part by mass of organohydrogenpolysiloxane (C-6) having the average compositional formula (10) was used instead of component (C-1) in Example 5.

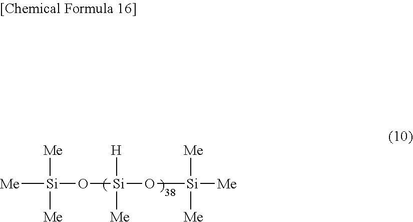

The resulting silicone PSA compositions were evaluated by the following tests.

### <Si—H Modification Degree>

The Si—H content (mol %) relative to all organic groups in the organohydrogenpolysiloxane as component (C) was determined.

### <Average Number of Si—O Units Between Si—H Groups>

It was calculated how far Si—H groups in component (C) were spaced apart from one another on average. Assuming that one MeHSiO_{2/2} was present at each end of the molecule except the terminal Me₃SiO_{1/2} units, the number of Me₂SiO_{2/2} present between Si—H groups was counted.

### <Curability>

A PSA article was prepared by mixing 100 parts by mass of the resulting silicone PSA composition with 0.2 Part by mass of silicone solution of 1,3-divinyl-1,1,3,3-tetramethyldisiloxane platinum(0) complex having a platinum content of 0.5 wt %, coating on a PET film of 23 μm thick and 25 mm wide by means of an applicator in such an amount as to form a PSA layer having a thickness of 30 μm after curing, and air drying in a dryer at 75° C. or 85° C. for 1 minute. The curability of the article was rated according to the following criterion by touching the adhesive layer with the finger.
◯: cured, no finger marks remained
Δ: undercured, finger marks remained
×: uncured and stringing

### <Rubber Hardness>

A cured product was prepared by mixing 100 parts by mass of the resulting silicone PSA composition with 0.2 Part by mass of silicone solution of 1,3-divinyl-1,1,3,3-tetramethyldisiloxane platinum(0) complex having a platinum content of 0.5 wt %, pouring into an aluminum container which had been treated with a parting agent, degassing, and drying in a dryer at 75° C. for 1 hour. The cured product was taken out of the container and measured for rubber hardness using an Asker C hardness meter (according to JIS S-6050).

### <Conformability to Unevenness>

A PSA article was prepared by mixing 100 parts by mass of the resulting silicone PSA composition with 0.2 Part by mass of silicone solution of 1,3-divinyl-1,1,3,3-tetramethyldisiloxane platinum(0) complex having a platinum content of 0.5 wt %, coating on a PET film of 23 m thick and 25 mm wide by means of an applicator in such an amount as to form a PSA layer having a thickness of 60 μm after curing, and air drying in a dryer at 75° C. for 3 minutes. The PET film of 23 μm thick with the PSA layer faced down was placed on a flat glass plate to bond the film to the glass, the appearance of which was observed and rated according to the following criterion.
◯: film is not lifted from glass
×: film is partially lifted from glass, leaving gaps between glass and film

The test results are shown in Table 1.

TABLE 1

| | | | | | | | | | | Si—H | Average | | | | |
|---|---|---|---|---|---|---|---|---|---|---|---|---|---|---|---|
| | | | | | | | | | | modifica- | number of | | | | Conform- |
| | | | | | | | | | | tion | Si—O units | | | | ability |
| | Ingredients, parts by mass | | | | | | | | | degree, | between Si—H | Curability | | Rubber | to |
| | A-1 | A-2 | B | C-1 | C-2 | C-3 | C-4 | C-5 | C-6 | mol % | groups | 75° C. | 85° C. | hardness | unevenness |
| Example 1 | 95 | | 5 | 9.81 | | | | | | 2.3 | 30 | ◯ | ◯ | 21 | ◯ |
| Example 2 | 95 | | 5 | | 3.35 | | | | | 6.5 | 8 | ◯ | ◯ | 28 | ◯ |
| Example 3 | 95 | | 5 | | | 1.61 | | | | 12.5 | 3 | ◯ | ◯ | 34 | ◯ |
| Example 4 | 95 | | 5 | | | | 0.83 | | | 24.8 | 1 | ◯ | ◯ | 38 | ◯ |
| Comparative | 95 | | 5 | | | | | 0.56 | | 33.9 | 0.4 | Δ | Δ | 42 | X |
| Example 1 | | | | | | | | | | | | | | | |
| Comparative | 95 | | 5 | | | | | | 0.4 | 46.3 | 0 | X | X | 42 | X |
| Example 2 | | | | | | | | | | | | | | | |
| Example 5 | | 60 | 40 | 9.57 | | | | | | 2.3 | 30 | ◯ | ◯ | 5 | ◯ |
| Example 6 | | 60 | 40 | | 3.27 | | | | | 6.5 | 8 | ◯ | ◯ | 7 | ◯ |
| Example 7 | | 60 | 40 | | | 1.57 | | | | 12.5 | 3 | ◯ | ◯ | 8 | ◯ |
| Example 8 | | 60 | 40 | | | | 0.81 | | | 24.8 | 1 | ◯ | ◯ | 10 | ◯ |
| Comparative | | 60 | 40 | | | | | 0.55 | | 33.9 | 0.4 | X | X | 10 | ◯ |
| Example 3 | | | | | | | | | | | | | | | |
| Comparative | | 60 | 40 | | | | | | 0.39 | 46.3 | 0 | X | X | 11 | ◯ |
| Example 4 | | | | | | | | | | | | | | | |

1. A solventless silicone pressure-sensitive adhesive composition comprising
(A) 40 to 100 parts by mass of an organopolysiloxane represented by the average compositional formula (1) and having at least two alkenyl-containing organic groups per molecule, 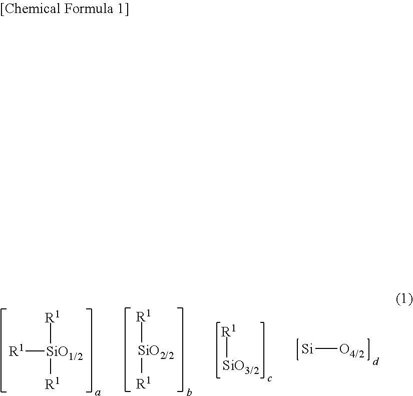
wherein R¹ which may be the same or different is a C₁-C₁₀ monovalent hydrocarbon group, at least two C₂-C₁₀ alkenyl-containing organic groups being contained, a is an integer of at least 2, b is an integer of at least 1, c and d each are an integer of at least 0, and 100≦a+b+c+d≦2,000,
(B) 0 to 60 parts by mass of an organopolysiloxane comprising R²₃SiO_{1/2} units and SiO_{4/2} units wherein R² is each independently an aliphatic unsaturation-free C₁-C₁₀ monovalent hydrocarbon group or C₂-C₆ alkenyl group, in a molar ratio R²₃SiO_{1/2}/SiO_{4/2} of 0.6 to 1.0, provided that the total of components (A) and (B) is 100 parts by mass,
(C) an organohydrogenpolysiloxane represented by the average compositional formula (2) and containing at least three Si—H groups per molecule, the content of Si—H groups being up to 30 mol % of all silicon-bonded organic groups, in an amount to provide 0.2 to 10 moles of Si—H groups per mole of alkenyl groups in components (A) and (B),
R³ₑH_{f}SiO_{(4-c-f)/2} (2)
wherein R³ is a substituted or unsubstituted C₁-C₁₀ monovalent hydrocarbon group, e and f are numbers in the range: e>0, f>0, and 0<e+f≦3, and
(D) a platinum group metal base catalyst for curing by promoting hydrosilylation addition reaction between alkenyl groups in component (A) and Si—H groups in component (C), in an amount to give 1 to 500 ppm of metal per 100 parts by mass of components (A), (B), and (C) combined.

2. The composition of claim 1, comprising 40 to 95 parts by mass of component (A) and 5 to 60 parts by mass of component (B).

3. The composition of claim 1 or 2 wherein component (C) has the general formula (3):
R⁴₃Si—O—(SiR⁵₂—O)_{g}—(SiR⁶H—O)ₕ—O—SiR⁷₃ (3)
wherein R⁴ and R⁷ each are a C₁-C₁₀ monovalent hydrocarbon group or hydrogen, R⁵ and R⁶ each are a C₁-C₁₀ monovalent hydrocarbon group, g and h are numbers in the range: 1≦g≦100 and 3≦h≦80.

4. The composition of claim 1 which cures at a temperature of 100° C. or lower.

5. The composition of claim 4 which cures at a temperature of 80° C. or lower.

6. The composition of claim 1 which cures into a cured product having a rubber hardness of up to 40 as measured by an Asker C hardness meter.

7. The composition of claim 1, further comprising (E) 0.005 to 2 parts by mass of a reaction regulator per 100 parts by mass of components (A), (B), and (C) combined.

8. A pressure-sensitive adhesive article obtained by coating and curing the solventless silicone pressure-sensitive adhesive composition of claim 1 onto a substrate.
